(19) United States
(12) Patent Application Publication
(10) Pub. No.: US 2015/0063329 A1
(43) Pub. Date: Mar. 5, 2015

(54) SELECTIVE VEHICLE WI-FI ACCESS

(71) Applicant: General Motors LLC, Detroit, MI (US)

(72) Inventors: Mark S. Frye, Grosse Pointe Woods, MI (US); Paul H. Pebbles, Novi, MI (US); Hassan Elnajjar, Dearborn, MI (US); Samer Zakhem, Troy, MI (US)

(73) Assignee: General Motors LLC, Detroit, MI (US)

(21) Appl. No.: 14/011,938

(22) Filed: Aug. 28, 2013

(51) Int. Cl. H04W 48/02

(52) U.S. Cl. CPC H04W 48/02
USPC 370/338

(57) ABSTRACT

A method and system of selectively permitting access to a vehicle Wi-Fi network includes establishing a plurality of vehicular Wi-Fi access levels each of which provide access to different features at a vehicle; generating a short-range wireless signal that provides Wi-Fi network access at the vehicle; associating a wireless device with one of the established vehicular Wi-Fi access levels; receiving an identity of the wireless device at the vehicle via the short-range wireless signal; determining the level of Wi-Fi access associated with the received identity using the vehicle telematics unit; and controlling access to the different features according to the determined level of Wi-Fi access level associated with the received identity.

### TECHNICAL FIELD

The present invention relates to wireless local area networks (WLANs), such as Wi-Fi networks, and more particularly to Wi-Fi networks located at a vehicle.

### BACKGROUND

Modern vehicles are often equipped with vehicle telematics units that provide a wide variety of services. For instance, vehicle telematics units can provide vehicle monitoring and diagnostic services as well as the ability to place and receive cellular calls that can communicate voice and/or data. Apart from these monitoring/diagnostic and cellular communication services, vehicle telematics units may also offer separate wireless devices the ability to communicate with the Internet through a WLAN generated by the vehicle, such as a Wi-Fi network. And in some implementations the Wi-Fi network at the vehicle can also be used as an access point for a vehicle owner, vehicle service provider, or other designated entity to access data and generally communicate with the vehicle. Given the available access to vehicle Wi-Fi networks for different wireless devices, it can be helpful to use a method and/or system for selectively permitting and/or restricting access to vehicle Wi-Fi networks.

### SUMMARY

According to an embodiment of the invention, there is provided a method of selectively permitting access to a vehicle Wi-Fi network. The method includes establishing a plurality of vehicular Wi-Fi access levels each of which provide access to different features at a vehicle; generating a short-range wireless signal that provides Wi-Fi network access at the vehicle; associating a wireless device with one of the established vehicular Wi-Fi access levels; receiving an identity of the wireless device at the vehicle via the short-range wireless signal; determining the level of Wi-Fi access associated with the received identity using the vehicle telematics unit; and controlling access to the different features according to the determined level of Wi-Fi access level associated with the received identity.

According to another embodiment of the invention, there is provided a method of selectively permitting access to a vehicle Wi-Fi network. The method includes accessing a Wi-Fi network provided by a vehicle via a short-range wireless signal; transmitting a wireless device identity to the vehicle via the short-range wireless signal; and receiving one of a plurality of vehicular Wi-Fi access levels that has been assigned to the wireless device identity, wherein each level provides access to different features at the vehicle based on the transmitted wireless device identity.

According to yet another embodiment of the invention, there is provided a system of selectively permitting access to a vehicle Wi-Fi network. The system comprises a vehicle telematics unit comprising a processor, a computer-readable medium, and a short-range wireless antenna, wherein the vehicle telematics unit: receives a plurality of wireless identities via a Wi-Fi network generated by the vehicle telematics unit through the short-range wireless antenna; correlates each of the plurality of wireless identities with one of a plurality of vehicular Wi-Fi access levels that each provide access to different features at the vehicle; storing the correlated wireless identities and vehicular Wi-Fi access levels in the computer-readable medium; and controlling access to features available through the Wi-Fi network based on the vehicular Wi-Fi access levels correlated with the wireless identity requesting the features.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein; and

FIG. 2 is a flow chart depicting an embodiment of a method of selectively permitting access to a vehicle Wi-Fi network.

### DETAILED DESCRIPTION OF THE ILLUSTRATED EMBODIMENTS

The method and system described below selectively permits or restricts wireless access to a vehicular Wi-Fi network based on a plurality of vehicular Wi-Fi access levels each of which permits/restricts access to different vehicle features. When a vehicle offers a vehicular Wi-Fi network, such a network can be used not only as a portal for wireless devices to access the Internet but it can also permit designated users access to selected vehicle features in addition to the Internet. On one hand, anyone with a wireless device, such as a smart phone, may be able to access the Wi-Fi network and connect with the Internet. On the other hand, designated individuals and entities can be granted access to vehicle features that other wireless device users are not. And a plurality of different Wi-Fi access levels can each grant access to a different bundle of features or services that are not available to others. As used herein, “Wi-fi” and “Wi-fi network” refer to any suitable short-range wireless communication, such as wireless local area network (WLAN) communication technologies. WLAN technologies can be based on 802.11 standards, WiMAX, and HiperLAN, for example, as well as other short-range communications, such as Bluetooth and other peer-to-peer communications technologies.

In one general example of how this can work, three different levels of vehicular Wi-Fi access can be established. Other implementations can use greater or fewer number of levels and the features permitted or restricted by each of the levels can also vary. But for purposes of illustrating how the method/system described herein can be implemented, three levels are described. For example, a first level of vehicular Wi-Fi access can restrict all functions other than access to the Internet. A second level of vehicular Wi-Fi access can be applied to wireless devices used by vehicle service personnel allowing access to the Internet as well as to vehicle information and data stored at the vehicle. While the second level of vehicular Wi-Fi access allows more than the first, the second level can block access that may normally be reserved for vehicle owners. With respect to vehicle owners and/or operators, a third level of vehicular Wi-Fi access can permit the vehicle owner or operator to access other features of the vehicle that would be restricted by the first and second levels. For instance, the third level of vehicular Wi-Fi access can permit the vehicle owner/operator wireless access to the contents of a hard drive that stores personal music/photographs or other features of the vehicle that may be reserved for vehicle owners/operators. The levels of vehicular Wi-Fi access and vehicle features associated with them will be discussed below in more detail.

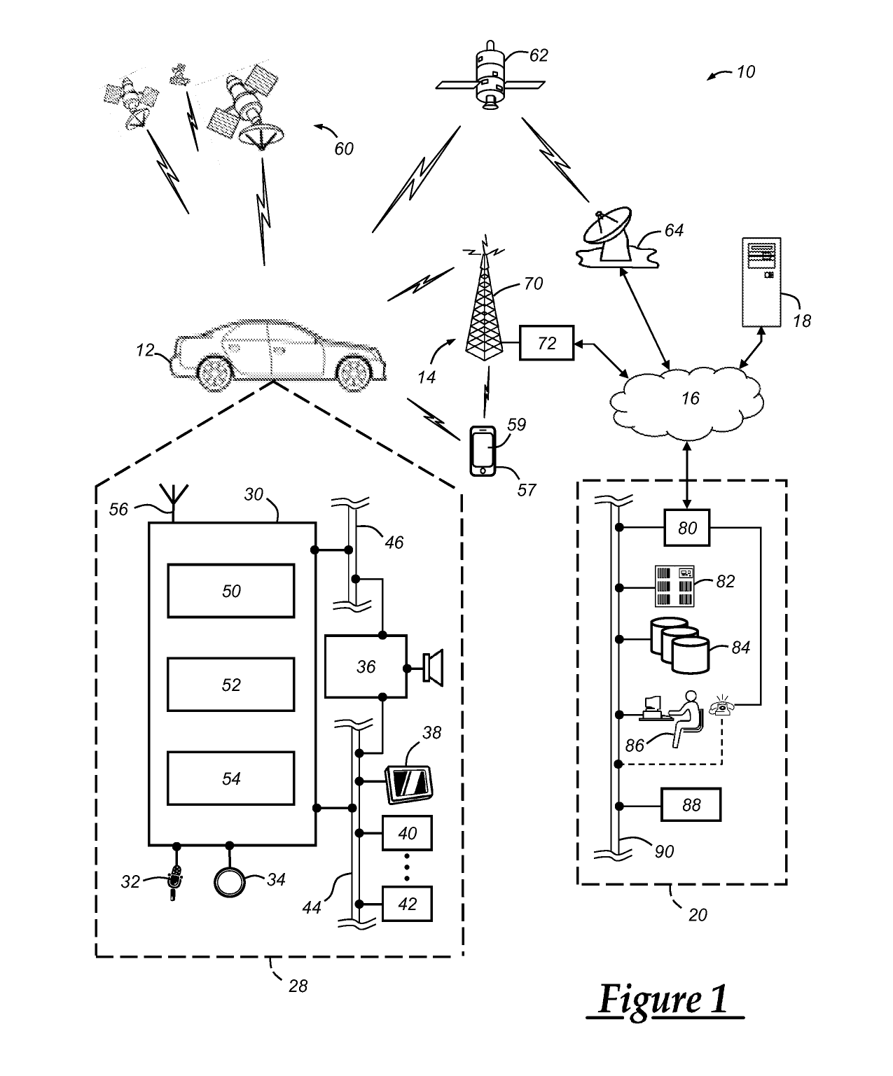

With reference to FIG. 1, there is shown an operating environment that comprises a mobile vehicle communications system 10 and that can be used to implement the method disclosed herein. Communications system 10 generally includes a vehicle 12, one or more wireless carrier systems 14, a land communications network 16, a computer 18, and a call center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 can be an OEM-installed (embedded) or aftermarket device that is installed in the vehicle and that enables wireless voice and/or data communication over wireless carrier system 14 and via wireless networking. This enables the vehicle to communicate with call center 20, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the call center 20) and data communication (e.g., to provide GPS location data or vehicle diagnostic data to the call center 20), the system can utilize a single call over a voice channel and switch as needed between voice and data transmission over the voice channel, and this can be done using techniques known to those skilled in the art.

According to one embodiment, telematics unit 30 utilizes cellular communication according to either GSM or CDMA standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as EVDO, CDMA, GPRS, and EDGE. Wireless networking between the vehicle and other networked devices can also be carried out using telematics unit 30 via a short-range wireless signal. For this purpose, telematics unit 30 can be configured to communicate wirelessly according to one or more wireless protocols, such as any of the IEEE 802.11 protocols, WiMAX, or Bluetooth, and be able to facilitate a Wi-Fi network known to those skilled in the art. When used for packet-switched data communication such as TCP/IP, the telematics unit can be configured with a static IP address or can set up to automatically receive an assigned IP address from another device on the network such as a router or from a network address server.

One of the networked devices that can communicate with the vehicle telematics unit 30 is a separate wireless device, such as a smart phone 57. The smart phone 57 can include computer processing capability, a transceiver capable of communicating using a short-range wireless protocol, and a visual smart phone display 59. In some implementations, the smart phone display 59 also includes a touch-screen graphical user interface and/or a GPS module capable of receiving GPS satellite signals and generating GPS coordinates based on those signals. Examples of the smart phone 57 include the iPhone™ manufactured by Apple, Inc. and the Android™ manufactured by Motorola, Inc. as well as others. These and other similar devices may be used or considered as a type of separate wireless device for the purposes of the method and system described herein. While the smart phone 57 is described as a wireless device used with the method/system, it should be appreciated that other similar and/or simpler wireless devices capable of short-range wireless communication can be successfully substituted for the smart phone 57 to carry out the method/system described herein. An iPad™ manufactured by Apple, Inc. is an example of such a wireless device that may lack cellular communication capability of the smart phone 57 yet be able to communicate with the Wi-Fi network.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services or features that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20 or other remote computer system, such as computer 18, for other purposes, such as fleet management. Also, new or updated map data can be downloaded to the GPS module 40 from the call center 20 via the telematics unit 30.

Apart from the audio system 36 and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to call center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or call center 20, or both. A computer 18 can also be used for providing Internet connectivity such as DNS services or as a network address server that uses DHCP or other suitable protocol to assign an IP address to the vehicle 12.

Call center 20 is designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live advisor phone can also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Database 84 can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 20 using live advisor 86, it will be appreciated that the call center can instead utilize VRS 88 as an automated advisor or, a combination of VRS 88 and the live advisor 86 can be used.

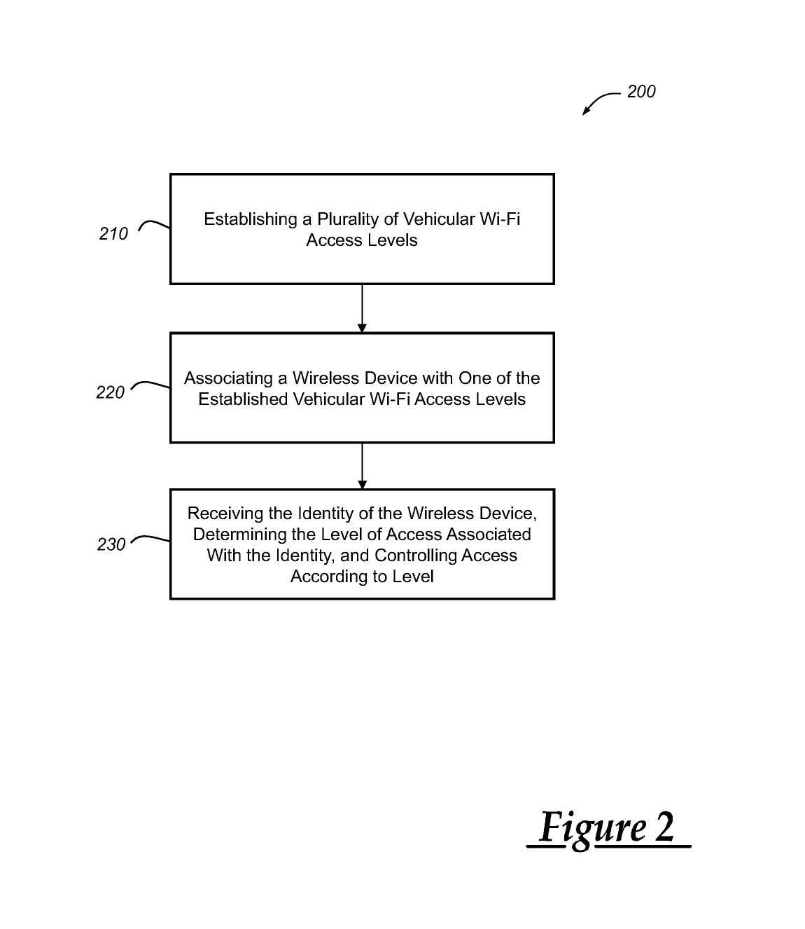

Turning now to FIG. 2, there is a flow chart of a method 200 of selectively permitting access to a vehicle Wi-Fi network. The method 200 begins at step 210 by establishing a plurality of vehicular Wi-Fi access levels each of which provide access to different features at the vehicle 12. As discussed above, access to a Wi-Fi network at the vehicle 12 can be controlled using multiple Wi-Fi access levels. In this implementation, three vehicular Wi-Fi access levels are described. A Wi-Fi access level can exclude access to all vehicle features allowing only access to the Internet or include one or more vehicle features in addition to Internet access. As used herein, vehicle features or services should be appreciated to include a vehicle function, access to vehicle data, or a service available through the Wi-Fi network. For example, a vehicle function can be the ability to remotely control the vehicle 12, such as by starting or locking/unlocking the vehicle 12. It can also describe access to DTCs or other vehicle data/information that represents vehicle operation. Vehicle features may also include the ability of a vehicle user/owner to access photographs or music stored in a computer-readable memory, such as digital memory devices 54, or to receive infotainment. Other vehicle features exist and these examples of vehicle features are merely illustrative of the various functions and services that can be regulated by the Wi-Fi access levels described herein.

In method 200, a first Wi-Fi access level can permit users of the Wi-Fi network provided by the vehicle 12 to access the Internet much like a wireless device, such as smart phone 57, would access a public Wi-Fi network. And a second Wi-Fi access level can provide access to vehicle features not available to wireless devices granted the first Wi-Fi access level. One example of the second Wi-Fi access level can permit a vehicle service department, such as a vehicle dealership, access to vehicle data. This vehicle data can include DTCs or other information that reflects the operating condition of the vehicle 12. In another example, the second Wi-Fi access level could be used for valet parking services and permit valet employees the ability to remotely lock/unlock and start the vehicle 12 as well as access the Internet through the Wi-Fi network. The third Wi-Fi access level can permit access to each vehicle feature offered by the vehicle 12. It should be appreciated that in other implementations only first and second Wi-Fi access levels may be used. Or that first, second, third, and fourth Wi-Fi access levels may be used. Ultimately, the number of Wi-Fi access levels can be varied as part of the method/system described herein. The method 210 proceeds to step 220.

At step 220, the wireless device is associated with one of the established vehicular Wi-Fi access levels. This can be accomplished in a variety of ways. In one implementation, one or more wireless devices, such as smart phone 57, can be provide its identity to the vehicle telematics unit 30 and the identity can be associated or correlated with one of the three Wi-Fi access levels used to access the Wi-Fi network provided by the vehicle telematics unit 30. For instance, the vehicle telematics unit 30 can receive the MAC address of the wireless device and correlate/associate one of the Wi-Fi access levels with the received MAC address. The correlated wireless identities and vehicular Wi-Fi access levels can then be stored in the digital memory devices 54. By correlating the identities of the wireless devices with the Wi-Fi access levels using the vehicle telematics unit 30, the vehicle telematics unit 30 can determine which vehicle features are permitted to each wireless device and can do so using a single Wi-Fi network. With respect to the single Wi-Fi network, this can be described by the vehicle 12 implementing a Wi-Fi network from the vehicle 12 by broadcasting a single network name or service set identifier (SSID).

In another implementation, the vehicle 12 can implement the Wi-Fi network by broadcasting a plurality of network names (e.g., SSIDs) and each network name can correspond to a different Wi-Fi access level. The wireless device using the Wi-Fi network in this implementation can receive the identity of a particular Wi-Fi access level in the form of a Wi-Fi network name and a password associated with the Wi-Fi network name. The Wi-Fi network name and associated password can be saved at the wireless device. That is, in a scheme that uses three Wi-Fi access levels, the vehicle telematics unit 30 can broadcast a first Wi-Fi network name that corresponds to the first Wi-Fi access level, a second Wi-Fi network name that corresponds to the second Wi-Fi access level, and a third Wi-Fi network name that corresponds to the third Wi-Fi access level. Wireless devices that are authorized to access vehicle features included with the second and third Wi-Fi access levels can each be directed to access the second Wi-Fi network name or third Wi-Fi network name, respectively. Individual passwords can be given to the second and/or third Wi-Fi network names. Thus, when a particular wireless device is designated as being able to access vehicle features granted by the second Wi-Fi network name, a second Wi-Fi network name password can permit that wireless device to access those features. Similarly, when a particular wireless device is designated as being able to access vehicle features granted by the third Wi-Fi network name, a third Wi-Fi network name password that is different from the second Wi-Fi network name password can permit that wireless device to access those features. In some implementations, the first Wi-Fi network name may not require a password. However, it is also possible to require that users of the first Wi-Fi network name use a password for access to the Internet. The method 200 proceeds to step 230.

At step 230, an identity of the wireless device is received at the vehicle 12 via the short-range wireless signal implementing the Wi-Fi network. The level of Wi-Fi access associated with the received identity is determined using the vehicle telematics unit 30 and controlled according to the determined level of Wi-Fi access associated with the received identity. Depending on how the Wi-Fi network is implemented, this can involve different steps. For instance, if the Wi-Fi network is implemented using a single network name, the vehicle telematics unit 30 can receive the identity of the wireless device, access stored combinations of wireless device identity/level of Wi-Fi access, and permit/deny access to vehicle functions. If the Wi-Fi network is implemented using multiple network names, the vehicle telematics unit 30 can verify passwords received from wireless devices and permit/deny access to vehicle functions based on the validity and identity of the passwords. The method 200 then ends.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of selectively permitting access to a vehicle Wi-Fi network, comprising the steps of:
(a) establishing a plurality of vehicular Wi-Fi access levels each of which provide access to different features at a vehicle;
(b) generating a short-range wireless signal that provides Wi-Fi network access at the vehicle;
(c) associating a wireless device with one of the established vehicular Wi-Fi access levels;
(d) receiving an identity of the wireless device at the vehicle via the short-range wireless signal;
(e) determining the level of Wi-Fi access associated with the received identity using the vehicle telematics unit; and
(f) controlling access to the different features according to the determined level of Wi-Fi access level associated with the received identity.

2. The method of claim 1, further comprising the step of establishing a first vehicular Wi-Fi access level that provides access to the Internet and excludes access to all vehicle features.

3. The method of claim 2, wherein access to the Internet is password-protected

4. The method of claim 2, further comprising the step of establishing a second vehicular Wi-Fi access level that provides access to a limited number of vehicle features as well as access to the Internet.

5. The method of claim 4, further comprising the step of establishing a third vehicular Wi-Fi access level that provides access to all vehicle features as well as access to the Internet.

6. The method of claim 1, further comprising the step of providing Wi-Fi network access via a single network name, wherein the vehicle telematics unit controls access to different features based on a wireless identity that is associated with a vehicular Wi-Fi access level and is stored with the vehicular Wi-Fi access level at the vehicle telematics unit.

7. The method of claim 1, further comprising the step of providing Wi-Fi network access via multiple network names, wherein each network name corresponds to a different vehicular Wi-Fi access level.

8. A method of selectively permitting access to a vehicle Wi-Fi network, comprising the steps of:
(a) accessing a Wi-Fi network provided by a vehicle via a short-range wireless signal;
(b) transmitting a wireless device identity to the vehicle via the short-range wireless signal;
(c) receiving one of a plurality of vehicular Wi-Fi access levels that has been assigned to the wireless device identity, wherein each level provides access to different features at the vehicle based on the transmitted wireless device identity.

9. The method of claim 8, further comprising the step of receiving a first vehicular Wi-Fi access level that provides access to the Internet and excludes access to vehicle features.

10. The method of claim 9, wherein access to the Internet is password-protected

11. The method of claim 9, further comprising the step of receiving a second vehicular Wi-Fi access level that provides access to a limited number of vehicle features as well as access to the Internet.

12. The method of claim 11, further comprising the step of receiving a third vehicular Wi-Fi access level that provides access to all vehicle features as well as access to the Internet.

13. The method of claim 8, further comprising the step of accessing the Wi-Fi network via a single network name, wherein the vehicle telematics unit controls access to different features based on a wireless identity that is associated with a vehicular Wi-Fi access level and is stored with the vehicular Wi-Fi access level at the vehicle telematics unit.

14. The method of claim 8, further comprising the step of providing Wi-Fi network access via multiple network names, wherein each network name corresponds to a different vehicular Wi-Fi access level.

15. A system of selectively permitting access to a vehicle Wi-Fi network, comprising:
a vehicle telematics unit comprising a processor, a computer-readable medium, and a short-range wireless antenna, wherein the vehicle telematics unit:
receives a plurality of wireless identities via a Wi-Fi network generated by the vehicle telematics unit through the short-range wireless antenna;
correlates each of the plurality of wireless identities with one of a plurality of vehicular Wi-Fi access levels that each provide access to different features at the vehicle;
storing the correlated wireless identities and vehicular Wi-Fi access levels in the computer-readable medium; and
controlling access to features available through the Wi-Fi network based on the vehicular Wi-Fi access levels correlated with the wireless identity requesting the features.
